(19) United States
(12) Patent Application Publication
(10) Pub. No.: US 2018/0335917 A1
(43) Pub. Date: Nov. 22, 2018

(54) SPACER, DISPLAY PANEL, METHOD FOR MANUFACTURING DISPLAY PANEL, AND DISPLAY DEVICE

(71) Applicants: BOE TECHNOLOGY GROUP CO., LTD., Beijing (CN); HEFEI XINSHENG OPTOELECTONICS TECHNOLOGY CO., LTD., Anhui (CN)

(72) Inventors: Jian ZHAO, Beijing (CN); Fengzhen LV, Beijing (CN); Jinliang LIU, Beijing (CN)

(73) Assignees: BOE TECHNOLOGY GROUP CO., LTD., Beijing (CN); HEFEI XINSHENG OPTOELECTRONICS TECHNOLOGY CO., LTD ., Anhui (CN)

(21) Appl. No.: 15/501,774

(22) PCT Filed: Sep. 20, 2016
(86) PCT No.: PCT/CN2016/099457

§ 371 Date: Feb. 3, 2017

(30) Foreign Application Priority Data
Oct. 23, 2015 (CN) 201510698699.8

(51) Int. Cl. G06F 3/0488

(52) U.S. Cl. CPC G06F 3/0488

(57) ABSTRACT

A spacer, a display panel, a method for manufacturing the display panel, and a display device are provided. The spacer includes a plurality of primary spacer portions and a plurality of connection portions. The plurality of primary spacer portions and the plurality of connection portions are arranged on the first substrate, and each connection portion is arranged between the adjacent primary spacer portions, so as to connect the adjacent primary spacer portions.

### CROSS-REFERENCE TO RELATED APPLICATION

The present application claims a priority of the Chinese patent application No. 201510698699.8 filed on Oct. 23, 2015, which is incorporated herein by reference in its entirety.

### TECHNICAL FIELD

The present disclosure relates to the field of display technology, in particular to a spacer, a display panel, a method for manufacturing the display panel, and a display device.

### BACKGROUND

As compared with a conventional cathode ray tube (CRT) display device, a liquid crystal display (LCD) has such advantages as being light and thin, low power consumption, being free of radiation and long service life, and thus has become a mainstream flat-panel display device and has been widely applied to electronic products such as mobile phone, computer, television and digital camera.

As an important component of the LCD, a liquid crystal display panel may include a color film substrate and an array substrate arranged opposite to each other. In order to ensure an even thickness of a cell of the liquid crystal display panel, usually a spacer having a certain thickness may be arranged between the array substrate and the color filter substrate. Usually, the spacer may include a ball spacer (BS) and a post spacer (PS). A height, a position and a profile of the post spacer may be accurately controlled through a photolithography process. Hence, in order to increase the display performance of the liquid crystal display panel, the post spacer takes advantages over the ball spacer.

However, in the related art, in the case that a strong force greater than the endurance of the spacer is applied to the liquid crystal display panel, the spacer may easily be broken. At this time, the spacer may fall off from the substrate where the spacer is arranged, and as a result, a display defect may occur for the liquid crystal display panel and the display quality of the liquid crystal display panel may be degraded.

### SUMMARY

An object of the present disclosure is to provide a spacer, a display panel, a method for manufacturing the display panel and a display device, so as to prevent the occurrence of the display defect and improve the display quality of the display panel.

In one aspect, the present disclosure provides in some embodiments a spacer arranged between a first substrate and a second substrate. The spacer includes a plurality of primary spacer portions and a plurality of connection portions. The plurality of primary spacer portions and the plurality of connection portions are arranged on the first substrate, and each connection portion is arranged between the adjacent primary spacer portions and configured to connect the adjacent primary spacer portions.

In a possible embodiment of the present disclosure, the spacer further includes a plurality of secondary spacer portions, and each secondary spacer portion is arranged on the corresponding connection portion.

In a possible embodiment of the present disclosure, each secondary spacer portion is arranged between the adjacent primary spacer portions, and more than one secondary spacer portions are arranged on the connection portion between the adjacent primary spacer portions.

In a possible embodiment of the present disclosure, a ratio of a height of each primary spacer portion to a height of each connection portion is greater than 6:5.

In a possible embodiment of the present disclosure, a ratio of a height of each primary spacer portion to a sum of a height of each connection portion and a height of each secondary spacer portion is smaller than 11:9.

In a possible embodiment of the present disclosure, the primary spacer portions, the connection portions and the secondary spacer portions are formed as an integral piece.

In a possible embodiment of the present disclosure, a transverse width of each primary spacer portion is smaller than a transverse width of each connection portion.

In another aspect, the present disclosure provides in some embodiments a display panel including a first substrate and a second substrate arranged opposite to each other, and the above-mentioned spacer arranged between the first substrate and the second substrate.

In yet another aspect, the present disclosure provides in some embodiments a display device including the above-mentioned display panel.

In still yet another aspect, the present disclosure provides in some embodiments a method for manufacturing a display panel, including: forming a spacer on a first substrate, the spacer including a plurality of primary spacer portions and a plurality of connection portions, each connection portion being arranged between the adjacent primary spacer portions and configured to connect the adjacent primary spacer portions; and enabling a second substrate to be arranged opposite to the first substrate, the plurality of primary spacer portions and the plurality of connection portions being arranged between the first substrate and the second substrate.

In a possible embodiment of the present disclosure, the spacer further includes a plurality of secondary spacer portions arranged on the connection portions.

In a possible embodiment of the present disclosure, forming the spacer on the first substrate includes: forming a spacer material layer on the first substrate; applying a photoresist onto the spacer material layer; exposing the photoresist with a mask plate, and developing the exposed photoresist, to form a photoresist fully-reserved region where the primary spacer portions are to be formed, a photoresist partially-reserved region where the connection portions and the secondary spacer portions are to be formed, and a photoresist unreserved region, wherein the photoresist partially-reserved region comprises a first photoresist partially-reserved region and a second photoresist partially-reserved region; etching off a portion of the spacer material layer corresponding to the photoresist unreserved region through a first etching process; removing the photoresist at the first photoresist partially-reserved region through a first ashing process; etching, through a second etching process, a portion of the spacer material layer exposed after the removal of the photoresist at the first photoresist partially-reserved region, to form parts of the connection portions below gaps between the secondary spacer portions; removing the photoresist at the second partially-reserved region through a second ashing process; etching, through a third etching process, a portion of the spacer material layer exposed after the removal of the photoresist at the second photoresist partially-reserved region, to form the secondary spacer portions and parts of the connection portions below the secondary spacer portions, wherein the connection portions comprise the parts below the gaps between the secondary spacer portions and the parts below the secondary spacer portions; and removing the photoresist at the photoresist fully-reserved region, to form the primary spacer portions.

According to the spacer, the display panel, the method for manufacturing the display panel and the display device in the embodiments of the present disclosure, the spacer is arranged between the first substrate and the second substrate, and the spacer includes the plurality of primary spacer portions and the plurality of connection portions. Each connection portion is arranged between the adjacent primary spacer portions and configured to connect the adjacent primary spacer portions. Through the connection portion arranged between the adjacent primary spacer portions, it is able to increase the endurance of the spacer to an external force, increase a contact area between the spacer and the first substrate and prevent the spacer from falling off the first substrate in the case that the spacer is broken. As a result, it is able to prevent the occurrence of the display defect and improve the display quality of the display panel.

### BRIEF DESCRIPTION OF THE DRAWINGS

FIG. 1a is a schematic view showing a spacer according to some embodiments of the present disclosure;

FIG. 1b is a plan view of a first substrate in FIG. 1a;

FIG. 2 is a schematic view showing a display panel according to some embodiments of the present disclosure;

FIG. 3 is a flow chart of a method for manufacturing the display panel according to some embodiments of the present disclosure;

FIG. 4 is a flow chart of a first step of the method in FIG. 3;

FIG. 5a is a schematic view showing the formation of a spacer material layer according to some embodiments of the present disclosure;

FIG. 5b is a schematic view showing the application of a photoresist according to some embodiments of the present disclosure;

FIG. 5c is a schematic view showing an exposing process with a mask plate according to some embodiments of the present disclosure; and

FIG. 5d is a schematic view showing the formation of primary spacer portions, connection portions and secondary spacer portions according to some embodiments of the present disclosure.

### DETAILED DESCRIPTION OF THE EMBODIMENTS

According to the present disclosure, the spacer, the display panel, the method for manufacturing the display panel and the display device will be described hereinafter in conjunction with the drawings and embodiments. The following embodiments are for illustrative purposes only, but shall not be used to limit the scope of the present disclosure.

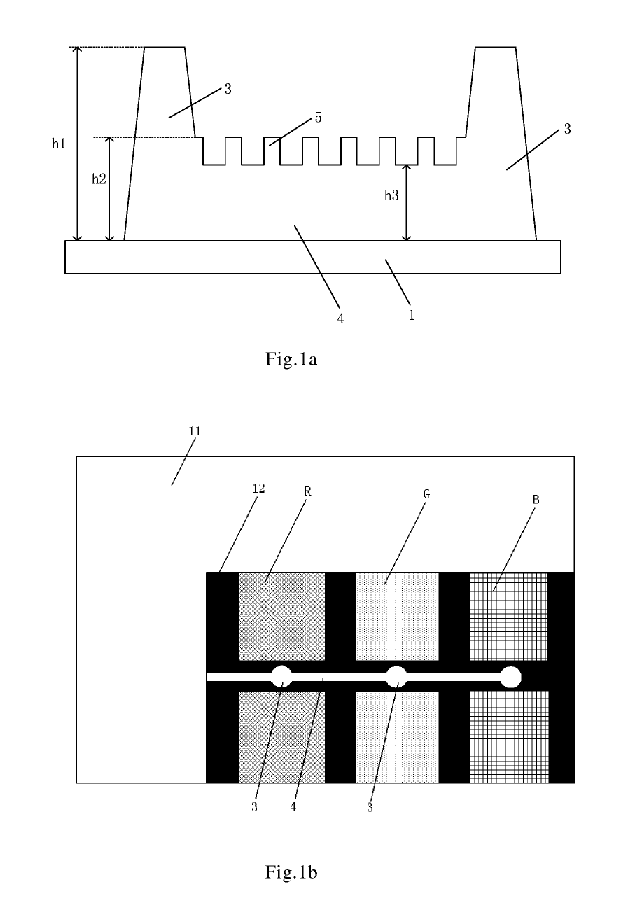

As shown in FIG. 1a, the present disclosure provides in some embodiments a spacer arranged between a first substrate 1 and a second substrate (not shown). The spacer includes a plurality of primary spacer portions 3 and a plurality of connection portions 4. The plurality of primary spacer portions 3 and the plurality of connection portions 4 are arranged on the first substrate 1, and each connection portion 4 is arranged between the adjacent primary spacer portions 3, so as to connect the adjacent primary spacer portions 3.

In the embodiments of the present disclosure, the plurality of primary spacer portions 3 is arranged on the first substrate 1, and the adjacent primary spacer portions 3 are separated from each other. In a possible embodiment of the present disclosure, the primary spacer portions 3 are arranged evenly. Each connection portion 4 is arranged between the adjacent primary spacer portions 3, such that each connection portion 4 may connect the adjacent primary spacer portions 3 to each other. Through the connection portions 4, is it is able to increase the endurance of the spacer to an external force.

In a possible embodiment of the present disclosure, the primary spacer portions 3 and the connection portions 4 are formed into an integral piece, so as to increase a contact are between the spacer and the first substrate 1, and prevent the spacer from falling off the first substrate 1 due to a large external force. In addition, the primary spacer portions and the connection portions may be formed through a single patterning process, so as to facilitate the manufacture thereof.

In addition, the spacer further includes a plurality of secondary spacer portions 5, each of which is arranged on the corresponding connection portion 4 and between the two adjacent primary spacer portions 3. In a possible embodiment of the present disclosure, more than one secondary spacer portions 5 may be arranged on the connection portion 4 between the adjacent primary spacer portions 3, and these secondary spacer portions 5 may be arranged evenly. Each secondary spacer portion 5 may function as a support between the first substrate 1 and the second substrate in the case that the primary spacer portion 3 is compressed to some extent, so as to maintain a cell thickness between the first substrate 1 and the second substrate.

In the embodiments of the present disclosure, a height h1 of each primary spacer portion 3 is greater than a height h3 of each connection portion 4. In a possible embodiment of the present disclosure, a ratio of the height h1 of the primary spacer portion 3 to the height h3 of the connection portion 4 is greater than 6:5, so as to improve the elasticity of the spacer.

In the embodiments of the present disclosure, the height h1 of each primary spacer portion 3 is greater than a sum h2 of the height of each connection portion 4 and a height of each secondary spacer portion 5. In a possible embodiment of the present disclosure, a ratio of the height of the primary spacer portion 3 to the sum h2 of the height of the connection portion 4 and the height of the secondary spacer portion 5 is smaller than 11:9, so as to improve a support capability of the secondary spacer portion 5.

In a possible embodiment of the present disclosure, each primary spacer portion 3 has a transverse width smaller than that of each connection portion 4. In this way, in the case that an external force is applied vertically to the primary spacer portion 3, the external force may be released by the primary spacer portion 3 to some extent in a transverse direction, so as to improve the elasticity of the primary spacer portion 3 without adverse impaction of the connection portion 4, thereby to ensure that the primary spacer portion 3 can adjust the cell thickness. In the embodiments of the present disclosure, the transverse direction refers to a direction in which the primary spacer portion 3 is connected to the connection portion 4 in FIG. 1a, and the transverse width refers to a width in FIG. 1a.

In a possible embodiment of the present disclosure, the primary spacer portions 3, the connection portions 4 and the secondary spacer portions 5 are formed into an integral piece, so as to increase a contact area between the spacer and the first substrate 1, and prevent the spacer from falling off the first substrate 1 due to a large external force applied thereto. In addition, it is able to form the primary spacer portions, the connection portions and the secondary spacer portions through a single exposing process, thereby to facilitate the manufacture and reduce the manufacture cost.

In the embodiments of the present disclosure, the first substrate 1 is a color filter substrate and the second substrate is an array substrate. In addition, a liquid crystal layer (not shown) is further arranged between the first substrate 1 and the second substrate (not shown).

As shown in FIG. 1b, which is a planar view of the first substrate 1 in FIG. 1a, the first substrate 1 is a color filter substrate and includes a base substrate 11 and black matrices 12 and color filter blocks arranged on the base substrate 11. The color filter blocks include a red color filter block R, a green color filter block G and a blue color filter block B. The primary spacer portions 3, the connection portions 4 and the secondary spacer portions 5 are all arranged on the black matrices 12. In a possible embodiment of the present disclosure, each connection portion 4 may be of a bar-like shape. The secondary spacer portions 5 are shown in FIG. 1a but not in FIG. 1b.

In the embodiments of the present disclosure, each primary spacer portion 3 is arranged as a support between the first substrate 1 and the second substrate, so as to maintain the cell thickness between the first substrate 1 and the second substrate. Each connection portion 4 functions as to connect the adjacent primary spacer portions 3, so as to increase the contact area between the spacer and the first substrate 1, thereby to prevent the spacer from falling off the first substrate 1 due to the large external force. In the case that the primary spacer portion 3 is deformed due to a strong external force applied thereto, the height of the primary spacer portion 3 may decrease to a value equal to the sum h2 of the height of the connection portion 4 and the height of the secondary spacer portion 5. At this time, the secondary spacer portion 5 may function as an auxiliary support between the first substrate 1 and the second substrate, so as to maintain the cell thickness between the first substrate 1 and the second substrate. In addition, in the case that an oversized external force has been applied to the display panel and the heights of the primary spacer portion 3 and the secondary spacer portion 5 have both decreased to a value equal to the height h3 of the connection portion 4, the connection portion 4 may further function as an auxiliary support between the first substrate 1 and the second substrate, so as to maintain the cell thickness between the first substrate 1 and the second substrate.

According to the embodiments of the present disclosure, the spacer includes the primary spacer portions and the connection portions, and each connection portion is arranged between the adjacent primary spacer portions and configured to connect the adjacent primary spacer portions. Through the connection portions arranged between the primary spacer portions, it is able to increase the endurance of the spacer to the external force, increase the contact area between the spacer and the first substrate and prevent the spacer from falling off the first substrate in the case that the spacer is broken, thereby to prevent the occurrence of the display defect and improve the display quality of the display panel. Through the secondary spacer portions arranged on the connection portions, it is able to further increase the endurance of the spacer to the external force.

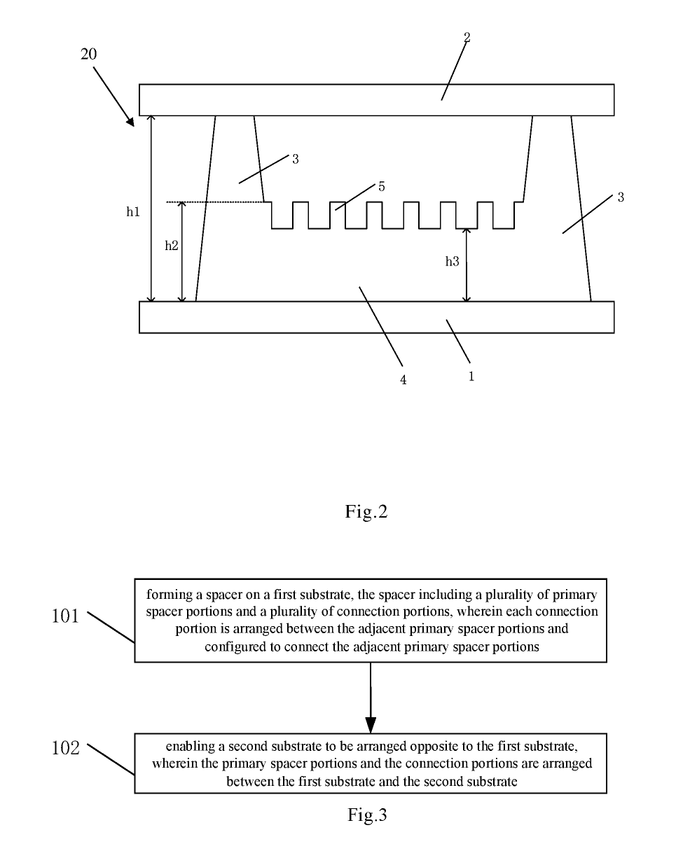

As shown in FIG. 2, the present disclosure provides in some embodiments a display panel 20, which includes the first substrate 1 and the second substrate 2 arranged opposite to each other, and the above-mentioned spacer arranged between the first substrate 1 and the second substrate 2. The Implementation of the spacer may refer to the above-mentioned embodiments, and thus will not be particularly defined herein.

According to the embodiments of the present disclosure, the display panel 20 includes the first substrate 1, the second substrate 2 and the spacer arranged between the first substrate 1 and the second substrate 2. The spacer includes the primary spacer portions 3 and the connection portions 4, and each connection portion 4 is arranged between the adjacent primary spacer portions 3 and configured to connect the adjacent primary spacer portions 3. Through the connection portions 4 between the adjacent primary spacer portions 3, it is able to increase the endurance of the spacer to the external force, increase the contact area between the spacer and the first substrate 1 and prevent the spacer from falling off the first substrate 1 in the case that the spacer is broken, thereby to prevent the occurrence of the display defect and improve the display quality of the display panel 20. Through the secondary spacer portion 5 on the connection portion 4, it is able to further increase the endurance of the spacer to the external force.

The present disclosure further provides in some embodiments a display device including the above-mentioned display panel.

According to the embodiments of the present disclosure, the spacer is arranged between the first substrate and the second substrate, the spacer includes the primary spacer portions and the connection portions, and each connection portion is arranged between the adjacent primary spacer portions and configured to connect the adjacent primary spacer portions. Through the connection portions arranged between the primary spacer portions, it is able to increase the endurance of the spacer to the external force, increase the contact area between the spacer and the first substrate and prevent the spacer from falling off the first substrate in the case that the spacer is broken, thereby to prevent the occurrence of the display defect and improve the display quality of the display panel. Through the secondary spacer portions arranged on the connection portions, it is able to further increase the endurance of the spacer to the external force.

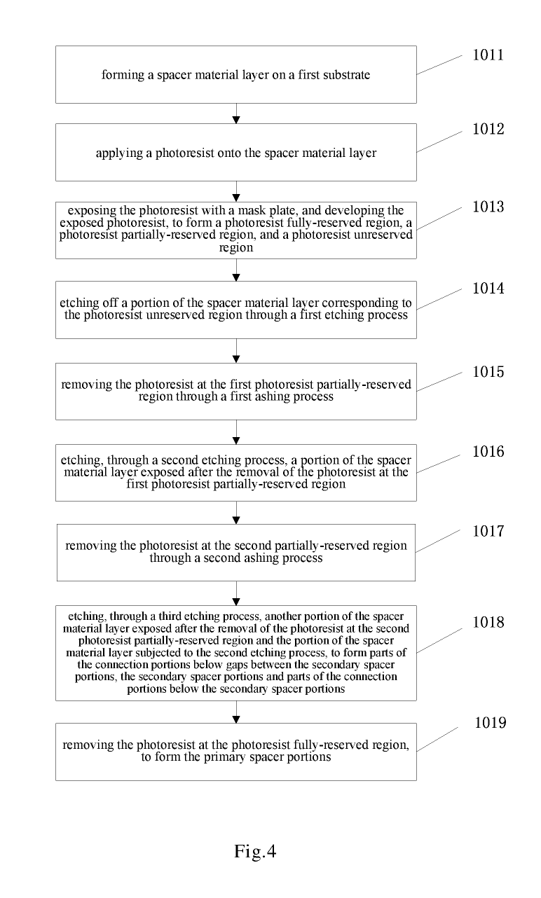

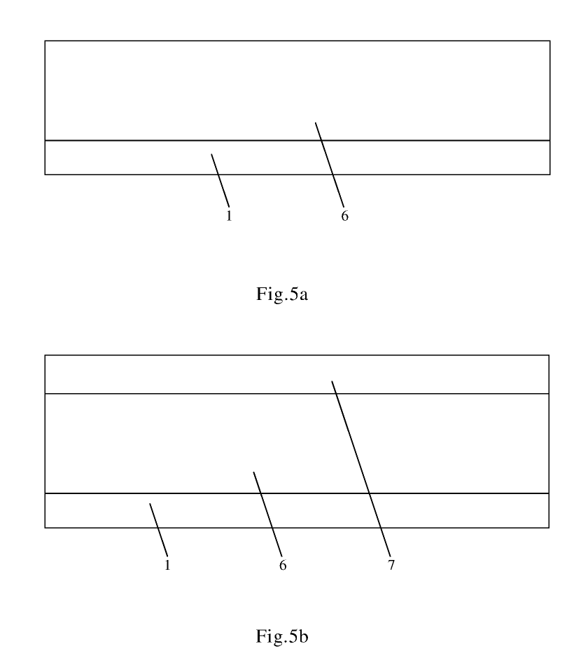

As shown in FIG. 3, the present disclosure further provides in some embodiments a method for manufacturing the display panel, which includes the following Step 101 and Step 102.

Step 101: forming a spacer on a first substrate. The spacer includes a plurality of primary spacer portions and a plurality of connection portions, and each connection portion is arranged between the adjacent primary spacer portions and configured to connect the adjacent primary spacer portions. In a possible embodiment of the present disclosure, the spacer further includes a plurality of secondary spacer portions, and each secondary spacer portion is arranged on the corresponding connection portion.

Step 101 may include Steps 1011 to 1019.

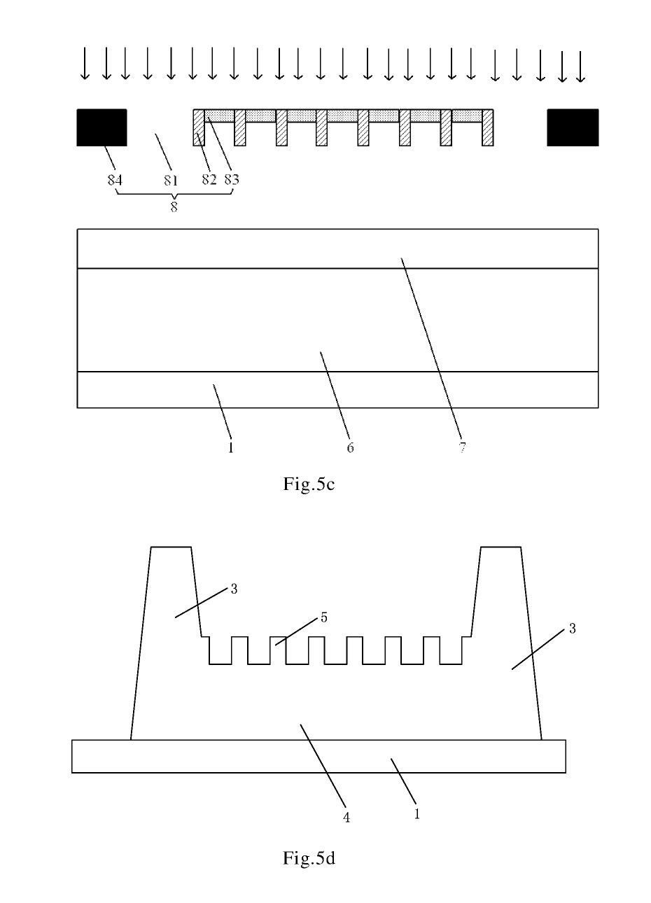

Step 1011: forming a spacer material layer on the first substrate. As shown in FIG. 5a, the spacer material layer 6 may be formed on the first substrate 1 and cover the entire first substrate 1.

Step 1012: applying a photoresist onto the spacer material layer. As shown in FIG. 5b, the photoresist 7 is applied onto the spacer material layer 6.

Step 1013: exposing the photoresist with a mask plate, and developing the exposed photoresist, so as to form a photoresist fully-reserved region where the primary spacer portions are to be formed, a photoresist partially-reserved region where the connection portions and the secondary spacer portions are to be formed, and a photoresist unreserved region.

As shown in FIG. 5c, the mask plate 8 may be a half-grayscale mask plate or halftone mask plate. The mask plate 8 may be placed above the photoresist 7 so as to expose the photoresist with the mask plate 8. The mask plate 8 includes a fully-transparent region 81, a semi-transparent region and a non-transparent region 84. The semi-transparent region includes a first semi-transparent region 82 and a second semi-transparent region 83. The fully-transparent region 81 corresponds to the photoresist fully-reserved region, the semi-transparent region corresponds to the photoresist partially-reserved region, and the non-transparent region 84 corresponds to the photoresist unreserved region. The photoresist partially-reserved region includes a first photoresist partially-reserved region and a second photoresist partially-reserved region. The first semi-transparent region 82 corresponds to the first photoresist partially-reserved region, and the second semi-transparent region 83 corresponds to the second photoresist partially-reserved region. The first semi-transparent region 82 is provided with light transmittance different from that of the second semi-transparent region 83, so after the exposing and developing procedures, the photoresist reserved at the first photoresist partially-reserved region has a thickness different from that of the photoresist reserved at the second photoresist partially-reserved region.

Step 1014: etching off a portion of the spacer material layer corresponding to the photoresist unreserved region through a first etching process.

Step 1015: removing the photoresist at the first photoresist partially-reserved region through a first ashing process. At this time, the photoresist at the second photoresist partially-reserved region and the photoresist at the photoresist fully-reserved region are reserved on the first substrate 1.

Step 1016: etching, through a second etching process, a portion of the spacer material layer exposed after the removal of the photoresist at the first photoresist partially-reserved region.

Step 1017: removing the photoresist at the second partially-reserved region through a second ashing process. At this time, the photoresist at the photoresist fully-reserved region is reserved on the first substrate 1.

Step 1018: etching, through a third etching process, a portion of the spacer material layer exposed after the removal of the photoresist at the second photoresist partially-reserved region and the portion of the spacer material layer subjected to the second etching process, to form parts of the connection portions below gaps between the secondary spacer portions, the secondary spacer portions and parts of the connection portions below the secondary spacer portions.

The connection portions 5 may be formed through the above-mentioned steps, and the connection portions 5 may include the parts of the connection portions below the gaps between the adjacent secondary spacer portions and the parts of the connection portions below the secondary spacer portions.

Step 1019: removing the photoresist at the photoresist fully-reserved region, so as to form the primary spacer portions.

As shown in FIG. 5d, through the above-mentioned steps, the primary spacer portions 3, the connection portions 4 and the secondary spacer portions 5 are formed on the first substrate 1.

Step 102: enabling a second substrate to be arranged opposite to the first substrate. The primary spacer portions and the connection portions are arranged between the first substrate and the second substrate. As shown in FIG. 1a, the first substrate 1 and the second substrate 2 are arranged opposite to each other to form a cell, thereby to acquire the display panel.

The method in the embodiments of the present disclosure may be used to manufacture the above-mentioned display panel, and the implementation of the display panel may refer to the above-mentioned embodiments.

According to the method for manufacturing the display panel in the embodiments of the present disclosure, the spacer is arranged between the first substrate and the second substrate, the spacer includes the primary spacer portions and the connection portions, and each connection portion is arranged between the adjacent primary spacer portions and configured to connect the adjacent primary spacer portions. Through the connection portions arranged between the primary spacer portions, it is able to increase the endurance of the spacer to the external force, increase the contact area between the spacer and the first substrate and prevent the spacer from falling off the first substrate in the case that the spacer is broken, thereby to prevent the occurrence of the display defect and improve the display quality of the display panel. Through the secondary spacer portions arranged on the connection portions, it is able to further increase the endurance of the spacer to the external force. In the actual implementation, the primary spacer portions, the connection portions and the secondary spacer portions may be formed through a single developing process, so as to facilitate the manufacture thereof, and reduce the manufacturing cost.

The above are merely the preferred embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

1. A spacer arranged between a first substrate and a second substrate, comprising a plurality of primary spacer portions and a plurality of connection portions, wherein the plurality of primary spacer portions and the plurality of connection portions are arranged on the first substrate, and each connection portion is arranged between the adjacent primary spacer portions and configured to connect the adjacent primary spacer portions.

2. The spacer according to claim 1, wherein the adjacent primary spacer portions are spaced apart from each other.

3. The spacer according to claim 1, wherein the plurality of primary spacer portions is arranged evenly.

4. The spacer according to claim 1, further comprising a plurality of secondary spacer portions arranged on the connection portions.

5. The spacer according to claim 4, wherein each secondary spacer portion is arranged between the adjacent primary spacer portions, and more than one secondary spacer portions are arranged on a connection portion between the adjacent primary spacer portions.

6. The spacer according to claim 5, wherein the plurality of secondary spacer portions are arranged between the adjacent primary spacer portions evenly.

7. The spacer according to claim 1, wherein a height of each primary spacer portion is greater than a height of each connection portion.

8. The spacer according to claim 7, wherein a ratio of the height of each primary spacer portion to the height of each connection portion is greater than 6:5.

9. The spacer according to claim 4, wherein a height of each primary spacer portion is greater than a sum of a height of each connection portion and a height of each secondary spacer portion.

10. The spacer according to claim 9, wherein a ratio of the height of each primary spacer portion to a sum of the height of each connection portion and the height of each secondary spacer portion is smaller than 11:9.

11. The spacer according to claim 4, wherein the primary spacer portions, the connection portions and the secondary spacer portions are formed into an integral piece.

12. The spacer according to claim 1, wherein a transverse width of each primary spacer portion is smaller than a transverse width of each connection portion.

13. A display panel, comprising:
a first substrate;
a second substrate arranged opposite to the first substrate; and
the spacer according to claim 1 arranged between the first substrate and the second substrate.

14. A display device comprising the display panel according to claim 13.

15. A method for manufacturing a display panel, comprising:
forming a spacer on a first substrate, wherein the spacer comprises a plurality of primary spacer portions and a plurality of connection portions, and each connection portion is arranged between the adjacent primary spacer portions and configured to connect the adjacent primary spacer portions; and
enabling a second substrate to be arranged opposite to the first substrate, wherein the plurality of primary spacer portions and the plurality of connection portions are arranged between the first substrate and the second substrate.

16. The method according to claim 15, wherein the spacer further comprises a plurality of secondary spacer portions arranged on the connection portions.

17. The method according to claim 15, wherein forming the spacer on the first substrate comprises:
forming a spacer material layer on the first substrate;
applying a photoresist onto the spacer material layer;
exposing the photoresist with a mask plate, and developing the exposed photoresist, to form a photoresist fully-reserved region where the primary spacer portions are to be formed, a photoresist partially-reserved region where the connection portions and the secondary spacer portions are to be formed, and a photoresist unreserved region, wherein the photoresist partially-reserved region comprises a first photoresist partially-reserved region and a second photoresist partially-reserved region;
etching off a portion of the spacer material layer corresponding to the photoresist unreserved region through a first etching process;
removing the photoresist at the first photoresist partially-reserved region through a first ashing process;
etching, through a second etching process, a portion of the spacer material layer exposed after the removal of the photoresist at the first photoresist partially-reserved region;
removing the photoresist at the second partially-reserved region through a second ashing process;
etching, through a third etching process, another portion of the spacer material layer exposed after the removal of the photoresist at the second photoresist partially-reserved region and the portion of the spacer material layer subjected to the second etching process, to form parts of the connection portions below gaps between the secondary spacer portions, the secondary spacer portions and parts of the connection portions below the secondary spacer portions, wherein the connection portions comprise the parts below the gaps between the secondary spacer portions and the parts below the secondary spacer portions; and
removing the photoresist at the photoresist fully-reserved region, to form the primary spacer portions.

18. The spacer according to claim 2, wherein the plurality of primary spacer portions is arranged evenly.

19. The spacer according to claim 2, further comprising a plurality of secondary spacer portions arranged on the connection portions.

20. The spacer according to claim 3, further comprising a plurality of secondary spacer portions arranged on the connection portions.
